(19) United States
(12) Patent Application Publication
(10) Pub. No.: US 2020/0396040 A1
(43) Pub. Date: Dec. 17, 2020

(54) EFFICIENT SIDELINK HARQ FEEDBACK TRANSMISSION

(71) Applicant: Honglei Miao, Munich (DE)

(72) Inventor: Honglei Miao, Munich (DE)

(21) Appl. No.: 16/913,059

(22) Filed: Jun. 26, 2020

Related U.S. Application Data
(60) Provisional application No. 62/876,517, filed on Jul. 19, 2019.

(51) Int. Cl. H04L 5/00; H04W 4/40; H04L 1/18

(52) U.S. Cl. CPC H04L 5/0055; H04L 1/1812; H04W 4/40

(57) ABSTRACT

Systems and methods for enabling HARQ feedback on a PFSCH to a groupcast PSSCH are described. A PFSCH resource pool configuration includes slot and subchannel parameters for HARQ feedback transmission by a UE in response a PSSCH. Upon a determination that HARQ feedback is to be transmitted, the UE selects time-frequency resources based on the resource pool configuration and transmits the PSFCH on the selected resources. If multiple geographic zones are defined by the RRC IE containing the resource pool configuration, the time-frequency resources are selected based on the zone and, if multiple sets of time-frequency resources are present in each zone, additional UE characteristics. If each zone has multiple sets of time-frequency resources, each set corresponds to a different coverage target.

### PRIORITY CLAIM

This application claims the benefit of priority to U.S. Provisional Patent Application Ser. No. 62/876,517, filed Jul. 17, 2019, which is incorporated herein by reference in its entirety.

### TECHNICAL FIELD

Aspects pertain to wireless communications. Some aspects relate to wireless networks including Third Generation Partnership Project (3GPP) Long Term Evolution (LTE) networks, 3GPP LTE Advanced (LTE-A) networks, fourth-generation (4G) and fifth-generation (5G) networks including 5G new radio (NR) (or 5G-NR) networks. Other aspects are directed to systems and methods for sidelink resource allocation and user equipment (UE) processing behaviors for NR sidelink communications, in particular Hybrid Automatic Repeat Request (HARQ) in sidelink communications.

### BACKGROUND

The use of 3GPP networks has increased due to both an increase in the types of devices user equipment (UEs) using network resources as well as the amount of data and bandwidth being used by various applications, such as video streaming, operating on these UEs. The 5G network, which like previous generations of networks includes both a radio-access network (RAN) and a core network (CN), has been developed to answer the enormous increase in number and diversity of communication devices, and are expected to increase throughput, coverage, and robustness and reduce latency and operational and capital expenditures. In addition to communication with the RAN, UE communications may include direct (sidelink) communications between the UE and other, non-RAN entities. Sidelink (SL) communications may involve their own challenges, including resource allocation for various types of communications.

### BRIEF DESCRIPTION OF THE FIGURES

In the figures, which are not necessarily drawn to scale, like numerals may describe similar components in different views. Like numerals having different letter suffixes may represent different instances of similar components. The figures illustrate generally, by way of example, but not by way of limitation, various embodiments discussed in the present document.

FIG. 1A illustrates an architecture of a network, in accordance with some aspects.

FIG. 1B illustrates a non-roaming 5G system architecture in accordance with some aspects.

FIG. 1C illustrates a non-roaming 5G system architecture in accordance with some aspects.

FIG. 2 illustrates a block diagram of a communication device in accordance with some embodiments.

FIG. 3 illustrates a method of providing feedback in sidelink communications in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

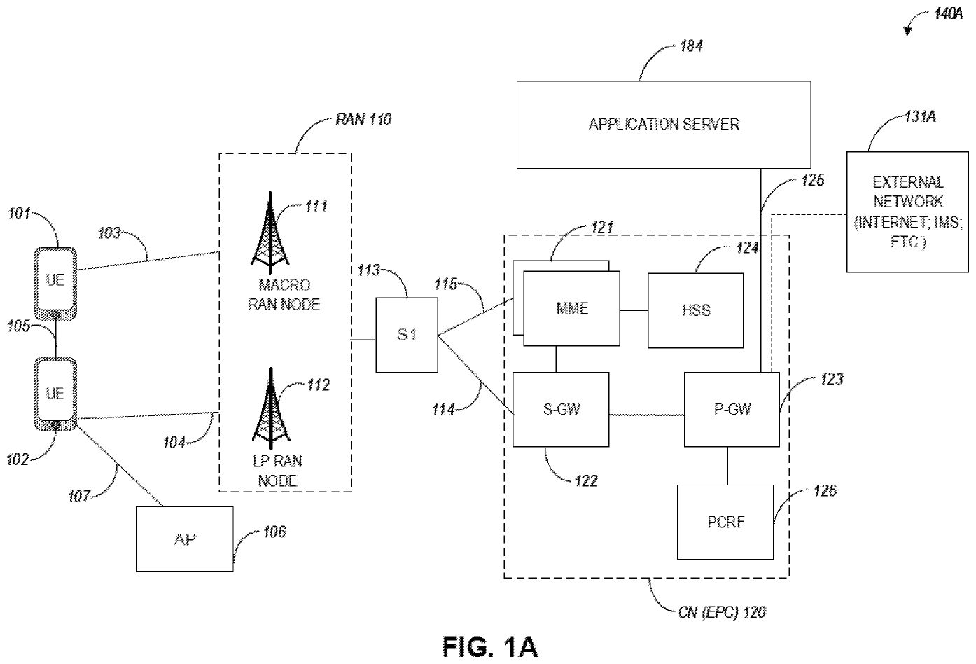

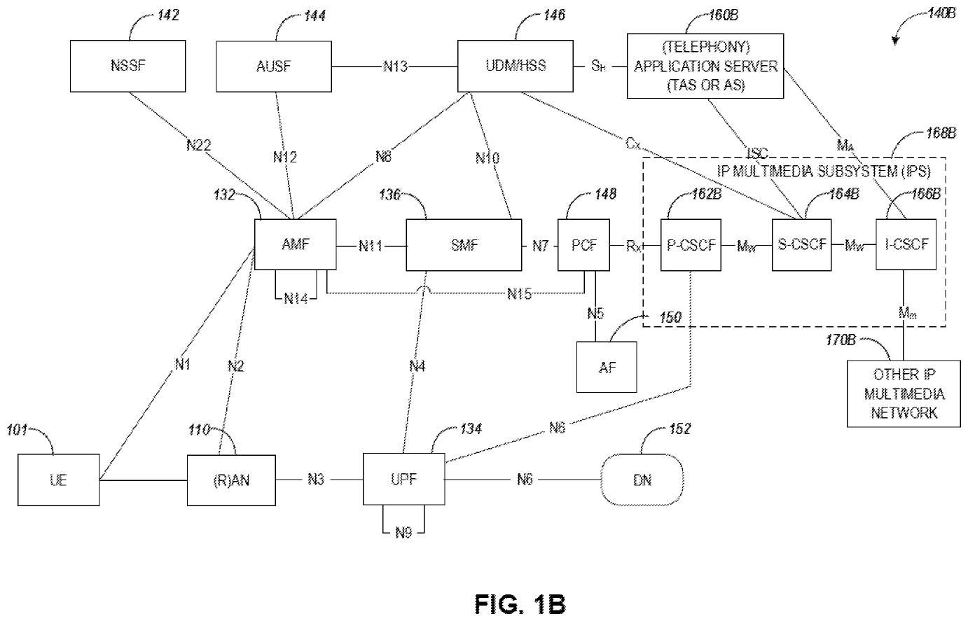

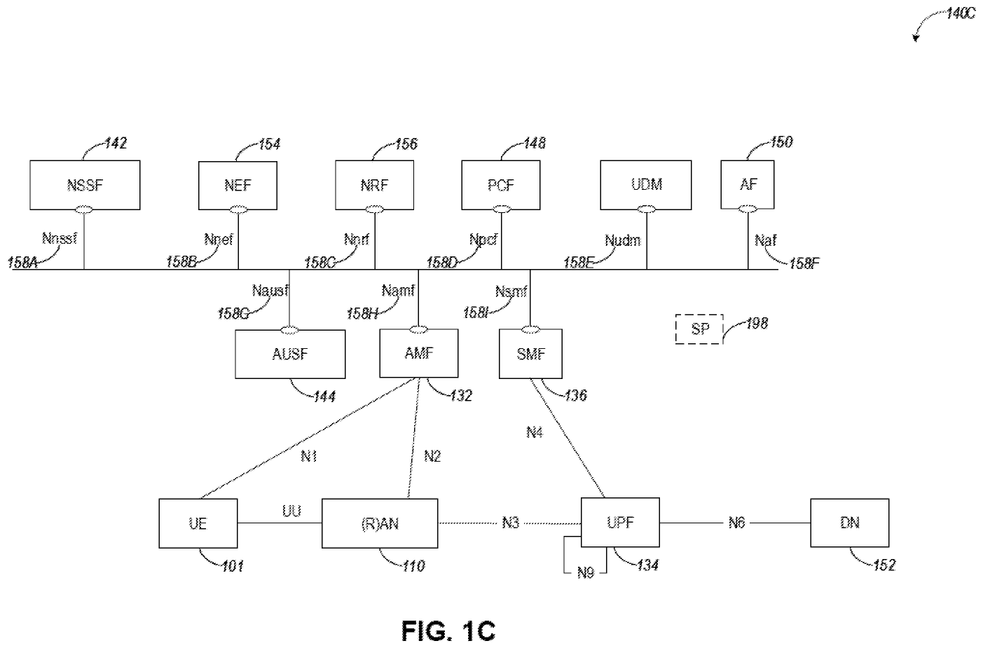

FIG. 1A illustrates an architecture of a network in accordance with some aspects. The network 140A includes 3GPP LTE/4G and NG network functions. A network function can be implemented as a discrete network element on a dedicated hardware, as a software instance running on dedicated hardware, and/or as a virtualized function instantiated on an appropriate platform, e.g., dedicated hardware or a cloud infrastructure.

The network 140A is shown to include user equipment (UE) 101 and UE 102. The UEs 101 and 102 are illustrated as smartphones (e.g., handheld touchscreen mobile computing devices connectable to one or more cellular networks) but may also include any mobile or non-mobile computing device, such as portable (laptop) or desktop computers, wireless handsets, drones, or any other computing device including a wired and/or wireless communications interface. The UEs 101 and 102 can be collectively referred to herein as UE 101, and UE 101 can be used to perform one or more of the techniques disclosed herein.

Any of the radio links described herein (e.g., as used in the network 140A or any other illustrated network) may operate according to any exemplary radio communication technology and/or standard. Any spectrum management scheme including, for example, dedicated licensed spectrum, unlicensed spectrum. (licensed) shared spectrum (such as Licensed Shared Access (LSA) in 2.3-2.4 GHz, 3.4-3.6 GHz, 3.6-3.8 GHz, and other frequencies and Spectrum Access System (SAS) in 3.55-3.7 GHz and other frequencies). Different Single Carrier or Orthogonal Frequency Division Multiplexing (OFDM) modes (CP-OFDM, SC-FDMA, SC-OFDM, filter bank-based multicarrier (FBMC). OFDMA, etc.), and in particular 3GPP NR, may be used by allocating the OFDM carrier data bit vectors to the corresponding symbol resources.

In some aspects, any of the UEs 101 and 102 can comprise an Internet-of-Things (IoT) UE or a Cellular IoT (CIoT) UE, which can comprise a network access layer designed for low-power IoT applications utilizing short-lived UE connections. In some aspects, any of the UEs 101 and 102 can include a narrowband (NB) IoT UE (e.g., such as an enhanced NB-IoT (eNB-IoT) UE and Further Enhanced (FeNB-IoT) UE). An ToT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network includes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network. In some aspects, any of the UEs 101 and 102 can include enhanced MTC (eMTC) UEs or further enhanced MTC (FeMTC) UEs.

The UEs 101 and 102 may be configured to connect, e.g., communicatively couple, with a radio access network (RAN) 110. The RAN 110 may be, for example, an Evolved Universal Mobile Telecommunications System (UMTS) Terrestrial Radio Access Network (E-UTRAN), a NextGen RAN (NG RAN), or some other type of RAN.

The UEs 101 and 102 utilize connections 103 and 104, respectively, each of which comprises a physical communications interface or layer (discussed in further detail below); in this example, the connections 103 and 104 are illustrated as an air interface to enable communicative coupling, and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth-generation (5G) protocol, a New Radio (NR) protocol, and the like.

In an aspect, the UEs 101 and 102 may further directly exchange communication data via a ProSe interface 105. The ProSe interface 105 may alternatively be referred to as a sidelink (SL) interface comprising one or more logical channels, including but not limited to a Physical Sidelink Control Channel (PSCCH), a Physical Sidelink Shared Channel (PSSCH), a Physical Sidelink Discovery Channel (PSDCH), a Physical Sidelink Broadcast Channel (PSBCH), and a Physical Sidelink Feedback Channel (PSFCH).

The UE 102 is shown to be configured to access an access point (AP) 106 via connection 107. The connection 107 can comprise a local wireless connection, such as, for example, a connection consistent with any IEEE 802.11 protocol, according to which the AP 106 can comprise a wireless fidelity (WiFi®) router. In this example, the AP 106 is shown to be connected to the Internet without connecting to the core network of the wireless system (described in further detail below).

The RAN 110 can include one or more access nodes that enable the connections 103 and 104. These access nodes (ANs) can be referred to as base stations (BSs), NodeBs, evolved NodeBs (eNBs), Next Generation NodeBs (gNBs), RAN nodes, and the like, and can comprise ground stations (e.g., terrestrial access points) or satellite stations providing coverage within a geographic area (e.g., a cell). In some aspects, the communication nodes 111 and 112 can be transmission/reception points (TRPs). In instances when the communication nodes 111 and 112 are NodeBs (e.g., eNBs or gNBs), one or more TRPs can function within the communication cell of the NodeBs. The RAN 110 may include one or more RAN nodes for providing macrocells, e.g., macro RAN node 111, and one or more RAN nodes for providing femtocells or picocells (e.g., cells having smaller coverage areas, smaller user capacity, or higher bandwidth compared to macrocells), e.g., low power (LP) RAN node 112.

Any of the RAN nodes 111 and 112 can terminate the air interface protocol and can be the first point of contact for the UEs 101 and 102. In some aspects, any of the RAN nodes 111 and 112 can fulfill various logical functions for the RAN 110 including, but not limited to, radio network controller (RNC) functions such as radio bearer management, uplink and downlink dynamic radio resource management and data packet scheduling, and mobility management. In an example, any of the nodes 111 and/or 112 can be a gNB, an eNB, or another type of RAN node.

The RAN 110 is shown to be communicatively coupled to a core network (CN) 120 via an S1 interface 113. In aspects, the CN 120 may be an evolved packet core (EPC) network, a NextGen Packet Core (NPC) network, or some other type of CN (e.g., as illustrated in reference to FIGS. 1B-1C). In this aspect, the S1 interface 113 is split into two parts: the S1-U interface 114, which carries traffic data between the RAN nodes 111 and 112 and the serving gateway (S-GW) 122, and the S1-mobility management entity (MME) interface 115, which is a signaling interface between the RAN nodes 111 and 112 and MMEs 121.

In this aspect, the CN 120 comprises the MMEs 121, the S-GW 122, the Packet Data Network (PDN) Gateway (P-GW) 123, and a home subscriber server (HSS) 124. The MMEs 121 may be similar in function to the control plane of legacy Serving General Packet Radio Service (GPRS) Support Nodes (SGSN). The MMEs 121 may manage mobility aspects in access such as gateway selection and tracking area list management. The HSS 124 may comprise a database for network users, including subscription-related information to support the network entities' handling of communication sessions. The CN 120 may comprise one or several HSSs 124, depending on the number of mobile subscribers, on the capacity of the equipment, on the organization of the network, etc. For example, the HSS 124 can provide support for routing/roaming, authentication, authorization, naming/addressing resolution, location dependencies, etc.

The S-GW 122 may terminate the S1 interface 113 towards the RAN 110, and routes data packets between the RAN 110 and the CN 120. In addition, the S-GW 122 may be a local mobility anchor point for inter-RAN node handovers and also may provide an anchor for inter-3GPP mobility. Other responsibilities of the S-GW 122 may include a lawful intercept, charging, and some policy enforcement.

The P-GW 123 may terminate an SGi interface toward a PDN. The P-GW 123 may route data packets between the EPC network 120 and external networks such as a network including the application server 184 (alternatively referred to as application function (AF)) via an Internet Protocol (IP) interface 125. The P-GW 123 can also communicate data to other external networks 131A, which can include the Internet, IP multimedia subsystem (IPS) network, and other networks. Generally, the application server 184 may be an element offering applications that use IP bearer resources with the core network (e.g., UMTS Packet Services (PS) domain, LTE PS data services, etc.). In this aspect, the P-GW 123 is shown to be communicatively coupled to an application server 184 via an IP interface 125. The application server 184 can also be configured to support one or more communication services (e.g., Voice-over-Internet Protocol (VoIP) sessions, PTT sessions, group communication sessions, social networking services, etc.) for the UEs 101 and 102 via the CN 120.

The P-GW 123 may further be a node for policy enforcement and charging data collection. Policy and Charging Rules Function (PCRF) 126 is the policy and charging control element of the CN 120. In a non-roaming scenario, in some aspects, there may be a single PCRF in the Home Public Land Mobile Network (HPLMN) associated with a UE's Internet Protocol Connectivity Access Network (IP-CAN) session. In a roaming scenario with a local breakout of traffic, there may be two PCRFs associated with a UE's IP-CAN session: a Home PCRF (H-PCRF) within an HPLMN and a Visited PCRF (V-PCRF) within a Visited Public Land Mobile Network (VPLMN). The PCRF 126 may be communicatively coupled to the application server 184 via the P-GW 123.

In some aspects, the communication network 140A can be an IoT network or a 5G network, including 5G new radio network using communications in the licensed (5G NR) and the unlicensed (5G NR-U) spectrum. One of the current enablers of oT is the narrowband-oT (NB-IoT). Operation in the unlicensed spectrum may include dual connectivity (DC) operation and the standalone LTE system in the unlicensed spectrum, according to which LTE-based technology solely operates in unlicensed spectrum without the use of an “anchor” in the licensed spectrum, called MulteFire. Further enhanced operation of LTE systems in the licensed as well as unlicensed spectrum is expected in future releases and 5G systems. Such enhanced operations can include techniques for sidelink resource allocation and UE processing behaviors for NR V2X sidelink communications.

An NG system architecture can include the RAN 110 and a 5G network core (5GC) 120. The NG-RAN 110 can include a plurality of nodes, such as gNBs and NG-eNBs. The core network 120 (e.g., a 5G core network or 5GC) can include an access and mobility function (AMF) and/or a user plane function (UPF). The AMF and the UPF can be communicatively coupled to the gNBs and the NG-eNBs via NG interfaces. More specifically, in some aspects, the gNBs and the NG-eNBs can be connected to the AMF by NG-C interfaces, and to the UPF by NG-U interfaces. The gNBs and the NG-eNBs can be coupled to each other via Xn interfaces.

In some aspects, the NG system architecture can use reference points between various nodes as provided by 3GPP Technical Specification (TS) 23.501 (e.g., V15.4.0, 2018-12). In some aspects, each of the gNBs and the NG-eNBs can be implemented as a base station, a mobile edge server, a small cell, a home eNB, and so forth. In some aspects, a gNB can be a master node (MN) and NG-eNB can be a secondary node (SN) in a 5G architecture.

FIG. 1B illustrates a non-roaming 5G system architecture in accordance with some aspects. In particular, FIG. 1B illustrates a 5G system architecture 140B in a reference point representation. More specifically. UE 102 can be in communication with RAN 110 as well as one or more other 5GC network entities. The 5G system architecture 140B includes a plurality of network functions (NFs), such as an AMF 132, session management function (SMF) 136, policy control function (PCF) 148, application function (AF) 150, UPF 134, network slice selection function (NSSF) 142, authentication server function (AUSF) 144, and unified data management (UDM)/home subscriber server (HSS) 146.

The UPF 134 can provide a connection to a data network (DN) 152, which can include, for example, operator services, Internet access, or third-party services. The AMF 132 can be used to manage access control and mobility and can also include network slice selection functionality. The AMF 132 may provide UE-based authentication, authorization, mobility management, etc., and may be independent of the access technologies. The SMF 136 can be configured to set up and manage various sessions according to network policy. The SMF 136 may thus be responsible for session management and allocation of IP addresses to UEs. The SMF 136 may also select and control the UPF 134 for data transfer. The SMF 136 may be associated with a single session of a UE 101 or multiple sessions of the UE 101. This is to say that the UE 101 may have multiple 5G sessions. Different SMFs may be allocated to each session. The use of different SMFs may permit each session to be individually managed. As a consequence, the functionalities of each session may be independent of each other.

The UPF 134 can be deployed in one or more configurations according to the desired service type and may be connected with a data network. The PCF 148 can be configured to provide a policy framework using network slicing, mobility management, and roaming (similar to PCRF in a 4G communication system). The UDM can be configured to store subscriber profiles and data (similar to an HSS in a 4G communication system).

The AF 150 may provide information on the packet flow to the PCF 148 responsible for policy control to support a desired QoS. The PCF 148 may set mobility and session management policies for the UE 101. To this end, the PCF 148 may use the packet flow information to determine the appropriate policies for proper operation of the AMF 132 and SMF 136. The AUSF 144 may store data for UE authentication.

In some aspects, the 5G system architecture 140B includes an IP multimedia subsystem (IMS) 168B as well as a plurality of IP multimedia core network subsystem entities, such as call session control functions (CSCFs). More specifically, the IMS 168B includes a CSCF, which can act as a proxy CSCF (P-CSCF) 162BE, a serving CSCF (S-CSCF) 164B, an emergency CSCF (E-CSCF) (not illustrated in FIG. 1B), or interrogating CSCF (I-CSCF) 166B. The P-CSCF 162B can be configured to be the first contact point for the UE 102 within the IM subsystem (IMS) 168B. The S-CSCF 164B can be configured to handle the session states in the network, and the E-CSCF can be configured to handle certain aspects of emergency sessions such as routing an emergency request to the correct emergency center or PSAP. The I-CSCF 166B can be configured to function as the contact point within an operator's network for all IMS connections destined to a subscriber of that network operator, or a roaming subscriber currently located within that network operator's service area. In some aspects, the I-CSCF 166B can be connected to another IP multimedia network 170E, e.g. an IMS operated by a different network operator.

In some aspects, the UDM/HSS 146 can be coupled to an application server 160E, which can include a telephony application server (TAS) or another application server (AS). The AS 160B can be coupled to the IMS 168B via the S-CSCF 164B or the I-CSCF 166B.

A reference point representation shows that interaction can exist between corresponding NF services. For example, FIG. 1B illustrates the following reference points: N1 (between the UE 102 and the AMF 132), N2 (between the RAN 110 and the AMF 132), N3 (between the RAN 110 and the UPF 134), N4 (between the SMF 136 and the UPF 134), N5 (between the PCF 148 and the AF 150, not shown), N6 (between the UPF 134 and the DN 152), N7 (between the SMF 136 and the PCF 148, not shown). N8 (between the UDM 146 and the AMF 132, not shown), N9 (between two UPFs 134, not shown), N10 (between the UDM 146 and the SMF 136, not shown), N11 (between the AMF 132 and the SMF 136, not shown), N12 (between the AUSF 144 and the AMF 132, not shown), N13 (between the AUSF 144 and the UDM 146, not shown), N14 (between two AMFs 132, not shown), N15 (between the PCF 148 and the AMF 132 in case of a non-roaming scenario, or between the PCF 148 and a visited network and AMF 132 in case of a roaming scenario, not shown). N16 (between two SMFs, not shown), and N22 (between AMF 132 and NSSF 142, not shown). Other reference point representations not shown in FIG. 1E can also be used.

FIG. 1C illustrates a 5G system architecture 140C and a service-based representation. In addition to the network entities illustrated in FIG. 1B, system architecture 140C can also include a network exposure function (NEF) 154 and a network repository function (NRF) 156. In some aspects, 5G system architectures can be service-based and interaction between network functions can be represented by corresponding point-to-point reference points Ni or as service-based interfaces.

In some aspects, as illustrated in FIG. 1C, service-based representations can be used to represent network functions within the control plane that enable other authorized network functions to access their services. In this regard, 5G system architecture 140C can include the following service-based interfaces: Namf 158H (a service-based interface exhibited by the AMF 132), Nsmf 1581 (a service-based interface exhibited by the SMF 136), Nnef 158B (a service-based interface exhibited by the NEF 154), Npcf 158D (a service-based interface exhibited by the PCF 148), a Nudm 158E (a service-based interface exhibited by the UDM 146), Naf 158F (a service-based interface exhibited by the AF 150), Nnrf 158C (a service-based interface exhibited by the NRF 156), Nnssf 158A (a service-based interface exhibited by the NSSF 142), Nausf 158G (a service-based interface exhibited by the AUSF 144). Other service-based interfaces (e.g., Nudr, N5g-eir, and Nudsf) not shown in FIG. 1C can also be used.

NR-V2X architectures may support high-reliability low latency sidelink communications with a variety of traffic patterns, including periodic and aperiodic communications with random packet arrival time and size. Techniques disclosed herein can be used for supporting high reliability in distributed communication systems with dynamic topologies, including sidelink NR V2X communication systems.

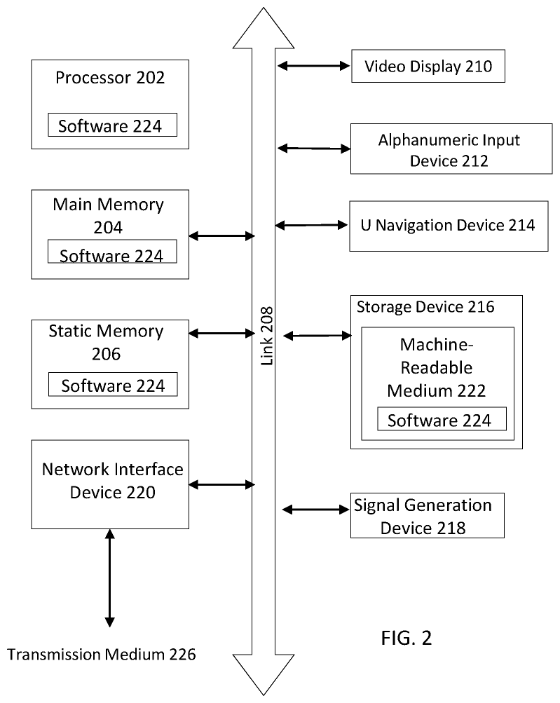

FIG. 2 illustrates a block diagram of a communication device in accordance with some embodiments. The communication device 200 may be a UE such as a specialized computer, a personal or laptop computer (PC), a tablet PC, or a smart phone, dedicated network equipment such as an eNB, a server running software to configure the server to operate as a network device, a virtual device, or any machine capable of executing instructions (sequential or otherwise) that specify actions to be taken by that machine. For example, the communication device 200 may be implemented as one or more of the devices shown in FIG. 1.

Examples, as described herein, may include, or may operate on, logic or a number of components, modules, or mechanisms. Modules and components are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” (and “component”) is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The communication device 200 may include a hardware processor 202 (e.g., a central processing unit (CPU), a GPU, a hardware processor core, or any combination thereof), a main memory 204 and a static memory 206, some or all of which may communicate with each other via an interlink (e.g., bus) 208. The main memory 204 may contain any or all of removable storage and non-removable storage, volatile memory or non-volatile memory. The communication device 200 may further include a display unit 210 such as a video display, an alphanumeric input device 212 (e.g., a keyboard), and a user interface (UI) navigation device 214 (e.g., a mouse). In an example, the display unit 210, input device 212 and UI navigation device 214 may be a touch screen display. The communication device 200 may additionally include a storage device (e.g., drive unit) 216, a signal generation device 218 (e.g., a speaker), a network interface device 220, and one or more sensors, such as a global positioning system (GPS) sensor, compass, accelerometer, or other sensor. The communication device 200 may further include an output controller, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 216 may include a non-transitory machine readable medium 222 (hereinafter simply referred to as machine readable medium) on which is stored one or more sets of data structures or instructions 224 (e.g., software) embodying or utilized by any one or more of the techniques or functions described herein. The instructions 224 may also reside, completely or at least partially, within the main memory 204, within static memory 206, and/or within the hardware processor 202 during execution thereof by the communication device 200. While the machine readable medium 222 is illustrated as a single medium, the term “machine readable medium” may include a single medium or multiple media (e.g., a centralized or distributed database, and/or associated caches and servers) configured to store the one or more instructions 224.

The term “machine readable medium” may include any medium that is capable of storing, encoding, or carrying instructions for execution by the communication device 200 and that cause the communication device 200 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Radio access Memory (RAM): and CD-ROM and DVD-ROM disks.

The instructions 224 may further be transmitted or received over a communications network using a transmission medium 226 via the network interface device 220 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks. Communications over the networks may include one or more different protocols, such as Institute of Electrical and Electronics Engineers (IEEE) 802.11 family of standards known as Wi-Fi, IEEE 802.16 family of standards known as WiMax, IEEE 802.15.4 family of standards, a Long Term Evolution (LTE) family of standards, a Universal Mobile Telecommunications System (UMTS) family of standards, peer-to-peer (P2P) networks, a next generation (NG)/5^{th} generation (5G) standards among others. In an example, the network interface device 220 may include one or more physical jacks (e.g., Ethernet, coaxial, or phone jacks) or one or more antennas to connect to the transmission medium 226.

As above, UEs may engage in sidelink communications. One such type of sidelink communications includes vehicle-to-anything (V2X) communications using, for example, resources provided by a base station. V2X communications may be part of a next generation Intelligent Transportation System (ITS) that is to be designed to take into account the massive influx of low-data, high-delay and low power transmissions. There may be multiple radio access technologies (RATs) available for communications by V2X UEs. V2X UEs (also called on-board units or OBUs) may be equipped with a range of multiple access technologies for V2X communications, using protocols such as Dedicated Short Range Communication (DSRC), LTE, and NR, each of which may be direct or network-mediated communication between OBUs. The DSRC suite of protocols is based on the IEEE 802.11 standards, adding modifications to the exchange of safety messages between vehicles and vehicles and roadside units (RSUs).

The types of communications in the ITS may include Vehicle-to-Vehicle (V2V) communications, Vehicle-to-Infrastructure (V2I) communications, Vehicle-to-Network (V2N) communications and Vehicle-to-Pedestrian (V2P) communications. The communications may occur over a PC5 reference point. V2X applications in the V2X UEs may communicate with other vehicle-based V2X applications (V2V communications), V2I communications may involve communications with an RSU and V2N communications may involve communications with an eNB (or E-UTRAN) to provide various V2X services. The communications among OBUs may be coordinated by a traffic management server.

V2I transmission may be provided between a vehicle and UE (RSU). V2N transmission may be between a vehicle and a V2X application server. A V2X Application Server may be able to support multiple V2X applications. An RSU may be used to extend the range of a V2X message received from a vehicle by acting as a forwarding node (e.g., repeater). V2I may include communication between vehicles and traffic control devices, such as in the vicinity of road work. V2N may also include communication between vehicle and the server via the 4G/5G network, such as for traffic operations. Thus, an RSU may support V2I service that can transmit to, and receive from, a UE using V2I applications. In various embodiments, the RSU may be implemented in an eNB or a stationary UE. The RSU may rebroadcast V2X messages for other vehicles (V2V), pedestrians (V2P), or various networks systems (V2I) using a multimedia broadcast multicast service (MBMS) for LTE.

It is expected that NR-V2X communication systems will support a wide variety of use cases and deployment scenarios including basic safety message exchange, advanced driving applications, and extended sensor sharing. While basic safety applications may largely reuse the channel access LTE design that is based on sensing performed at the transmitter side, advanced applications may involve channel access schemes based on a combination of transmitter and receiver-based sensing to achieve higher data rates and reliability. Independent of the type of application, Hybrid Automatic Repeat reQuest (HARQ) feedback and HARQ combining in the physical layer may be used to improve the link performance of a sidelink communications. HARQ-ACK (Acknowledge) or HARQ-NACK (Non-Acknowledge) feedback for data transmitted in the Physical Sidelink Shared Channel (PSSCH) may be carried in the Sidelink Feedback Control Information (SFCI) format(s) via the Physical Sidelink Feedback Control Channel (PSFCH) in resource allocation modes 1 (network controlled allocation) and 2 (autonomous allocation) for sidelink unicast and groupcast communications.

Techniques discussed herein can be used for sidelink resource allocation schemes, in particular for HARQ-ACK communications. HARQ options may include NACK-only feedback (i.e., provide HARQ-ACK signaling only when a NACK is to be sent) and ACK/NACK feedback (i.e., provide HARQ-ACK signaling when either an ACK or a NACK is to be sent). NR sidelink communication may support both option 1) NACK-only feedback and option 2) ACK/NACK feedback.

For groupcast with option 1, it may be also possible that a V2X RX UE (i.e., a V2X receiver) decides not to send the HARQ feedback, even though transmission of the feedback may be (pre-)configured. The ability to avoid transmission of the HARQ feedback may be beneficial to reduce channel congestion. The criteria according to which the V2X RX UE can decide whether or not to transmit the HARQ feedback can be based on either Reference Signal Receive Power (RSRP) at the V2X RX UE and/or the distance between the TX UE and the RX UEs. Specifically, distance-based HARQ feedback can be a good option for scenarios where, for instance, UEs physically close to each other but blocked by blockers may have very short radio distance. However, such functionality may yield additional overhead since position-related information may be transmitted to the RX UE. Therefore, it may be beneficial to support both RSRP-based and distance-based HARQ feedback, which can be (pre-)configured. Furthermore, it may be possible that a network (pre-)configures a UE to use both RSRP-based and distance-based HARQ feedback, and the UE may only be allowed to skip HARQ feedback transmission when both criteria are not met.

For at least option 1, e.g., TX-RX distance-based HARQ feedback for groupcast, a UE may transmit HARQ feedback for the PSSCH if the TX-RX distance is smaller or equal to the communication range parameter. Otherwise, the UE does not transmit HARQ feedback for the PSSCH. A TX UE's location may be indicated by Sidelink Control Information (SCI) associated with the PSSCH. The manner in which the TX locations can be defined and signaled in SCI (in a set of communication range parameters) is indicated below, as well as the manner in which the TX-RX distance is estimated by the RX UE based on its own location and TX UE location. The used communication range parameter for a PSSCH may be known after decoding SCI associated with the PSSCH.

Whether and how the communication range parameter is implicitly or explicitly signaled may be one issue to resolve. In some aspects, when the PSFCH in a slot is in response to a single PSSCH, an implicit mechanism may be used to determine the frequency and/or code domain resource of the PSFCH within a configured resource pool. At least the following parameters may be used in the implicit mechanism: 1) a slot index associated with PSCCH/PSSCH/PSFCH, 2) one or more sub-channel(s) associated with PSCCH/PSSCH, and 3) an identifier to distinguish each RX UE in a group for Option 2 groupcast HARQ feedback.

Specifically, various methods may be used to provide detailed PSFCH resource pool configuration including time and frequency resource allocation for PSFCH, and PSFCH selection option. Moreover, a PSFCH zone configuration may be used to enable location-dependent PSFCH resource allocation. A PSFCH resource set associated with particular selection criteria may be used to enable link adaptation for PSFCH transmission. As a result, a comprehensive PSFCH resource pool configuration may furnish efficient PSFCH transmission schemes to achieve energy- and spectrum-efficient SL communication. These methods may be used to realize PSFCH resource pool, PSFCH zone and PSFCH resource set configurations. As a result, PSFCH resources can be flexibly chosen by the V2X RX UE dependent on the existing scenario.

Method 1 may include the use of a radio resource control (RRC) information element (IE) for PSFCH resource pool configuration that can be (pre)configured for each SL V2X UE. The RRC IE may be provided in an RRC reconfiguration message (RRCReconfiguration) during initial attachment of the UE to the RAN, for example. The RRC IE may be a SL-V2X-PSFCHResourcePoolConfig parameter (or field). The PSFCH resource pool configuration may include a time-frequency resource pool configuration, i.e., slot and subchannel parameters. In addition, a PSFCH allocation scheme can also be (pre-)configured by the resource pool. The PSFCH allocation scheme may include non- or co-located PSFCH and PSSCH. The SL-V2X-PSFCHResourcePoolConfig can be defined as:

```
    SL-V2X-PSFCHResourcePoo1Config ::=  SEQUENCE {
      slotOffsetMin ENUMERATED {s11, s12, s14, s18, spare1},
      slotOffsetMax ENUMERATED {s11, s12, s14, s18, spare1}, OPTIONAL
    slotBitmap SL-V2X-SlotBitmap,
    nrofLastSymbols-PSFCH ENUMERATED {n1, n2, n4, n7, n14},
        sameSubchannel-PSSCHIndicator BOOLEAN,
  sizeSubchannel ENUMERATED {n2, n4, n8, n16, n32, spare1},
  nrofSubchannels ENUMERATED
  {n1, n3, n5, n8, n10, n15, n20, spare1}
OPTIONAL
      startRB-PSFCH INTEGER (0..99) OPTIONAL, -- Need OR
    }
    SL-V2X-SlotBitmap ::=  CHOICE {
      bs10 BIT STRING (SIZE (10)),
      bs16 BIT STRING (SIZE (16)),
      bs20 BIT STRING (SIZE (20)),
      bs30 BIT STRING (SIZE (30)),
      bs40 BIT STRING (SIZE (40)),
      bs50 BIT STRING (SIZE (50)),
      bs60 BIT STRING (SIZE (60)),
      bs100 BIT STRING (SIZE (100))
}
```

where the slotOffsetMin (K_min) parameter may define the minimum slot offset with respect to the slot of the received PSSCH on which the PSFCH can be transmitted. For example, if the last symbol of the PSSCH is received at slot n, the PSFCH transmitting the HARQ-ACK for the PSSCH may be transmitted in slot n+a, where a is equal or larger than K_min.

Similarly, the slotOffsetMax (K_max) parameter may define the maximum slot offset with respect to the slot of the received PSSCH on which the PSFCH can be transmitted. For example, if the last symbol of the PSSCH is received at slot n, the PSFCH transmitting the HARQ-ACK for the PSSCH may be transmitted in slot n+a, where a is equal or less than than K_max.

The slotBitmap parameter may define the bitmap pattern for the set of slots where the PSFCH are allocated. If a bit is set to 1, the associated slot can be used for PSFCH transmission, otherwise, no PSFCH is allocated in the slot. The periodicity of PSFCH slot pattern may depend on the length of bitmap.

The nrofLastSymbols-PSFCH parameter may define the number of last OFDM symbols in a PSFCH slot to be used for PSFCH transmission.

The sameSubchannel-PSSCHIndicator parameter (indicator bit) may define whether the same subchannel is to be used for the PSSCH and PSFCH. When the PSFCH does not use the same subchannel as the PSSCH due to the indicator being set to False, the exact frequency resources to be used by the PSFCH can be either explicitly signaled in the SCI or implicitly determined by the V2X RX UEs based on rules specified in the 3GPP standard.

The sizeSubchannel parameter may define the number of resource blocks per PSFCH subchannel.

The nrofSubchannels parameter may define the number of subchannels in the PSFCH resource pool.

The startRB-PSFCH parameter may define the number of start resource blocks in the carrier bandwidth. If the startRB-PSFCH parameter field is absent, the start resource block of the PSFCH may be same as that of the PSSCH.

Thus, the SL-V2X-PSFCHResourcePoolConfig parameter may be used to indicate the timing window (slotOffsetMin, slotOffsetMax), the placement (symbol) within the timing window (slotBitmap, nrofLastSymbols), and the frequency (sameSubchannel-PSSCHIndicator, sizeSubchannel, nrofSubchannels, startRB-PSFCH) for transmission of the PFSCH.

Method 2 may include the use of a PFSCH resource zone allocation. In this method, the PSFCH zone configuration can be included in the PSFCH resource pool configuration (in addition to the information of the IE described in Method 1, above), thereby allowing V2X RX UEs located in different zones with respect to the V2X TX UE to be able to use different PSFCH resources for transmission of a HARQ-ACK response to the received groupcast PSSCH. The SL-V2X-PSFCHResourcePoolConfig may be used as the PSFCH zone configuration in Method-1. For the Option-1 HARQ response (i.e., a NACK-or-DTX response/transmission of a NACK or no transmission), one PSFCH resource can be configured per PSFCH zone. For the Option-2 HARQ response (i.e., a NACK-or-ACK response/transmission of an ACK or NACK response), a pair of PSFCH resources can be configured per PSFCH zone. When multiple PSFCH resources are configured in the zone, the RX UE can choose the PSFCH resource based on its location ID (L_zone), within the zone. Alternatively, or in addition, the RX UE can choose the PSFCH resource based on its layer 1 ID (L1_ID). Specifically, the RRC parameters of the SL-V2X-PSFCHResourcePoolConfig parameter that enables PSFCH zone configuration are:

```
SL-V2X-PSFCHResourcePoolConfig ::= SEQUENCE {
    . . . . . .
  zone-PSFCHConfig SEQUENCE {
      zoneLengthENUMERATED
      { m5, m10, m20, m50, m100, m200, m500, spare1},
      zoneWidth ENUMERATED
      { m5, m10, m20, m50, m100, m200, m500, spare1},
      zoneIdLongiMod INIEGER (1..4),
      zoneIdLatiMod INTEGER (1..4)
  }
    . . . . . .
}
```

where the zoneLength parameter (L) may define the length of the location zone, and mx may denote x meter; zoneWidth (W) may define the width of the location zone; zoneIdLongiMod (Nx) may define the range of the location zone ID in longitude direction; and zoneidLatiMod (Ny) may define the range of location zone ID in latitude direction.

The zone ID (z_ID) can be calculated as follows:

z_ID=mod(y/W,Ny)*Nx+mod(x/L,Nx)+1

where x may define the location of the V2X UE in longitude and y may define the location of the V2X UE in latitude. As is apparent, z_ID ranges from 1 to N_ID=Nx*Ny. With the assumption that the N_PSFCH_pool resources are defined in the PSFCH resource pool, the N_PSFCH_pool resources may be evenly allocated to the N_ID zones. As a result, each zone may be allocated with N_PSFCH_zone=N_PSFCH_pool/N_ID PSFCH resources. When multiple PSFCH resources are allocated in each zone (N_PSFCH_zone>1), the RX UE can choose one PSFCH resource valid in the zone either randomly or based on predetermined rule. In some aspects, the RX UE can choose the PSFCH resource based on its location ID (L_zone) within the zone. For example, a PSFCH resource with index r_PSFCH=mod(L_zone, N_PSFCH_zone) in the zone can be selected by the RX UE. The location ID L_zone within the zone can be obtained by virtue of a location zone configuration with a zone area smaller than the PSFCH resource zone. In some aspects, the RX UE can choose the PSFCH resource based on its layer 1 ID (L1_ID). For example, the PSFCH resource with index r_PSFCH=mod(L1_ID, N_PSFCH_zone) in the zone can be selected by the RX UE.

The use of zone information can permit different RX V2X UEs in different geographic zones that have received the groupcast PSSCH to provide the PSFCH using different resources.

Method 3 may include the use of link adaption for PSFCH transmission. In this method, PSFCH resources with different coverage target (i.e., selection criteria) can be configured in a PSFCH resource pool on a zone basis, again extending the PSFCH method from that of Method 2. In the PSFCH resource pool, PSFCH resources can be arranged into different sets of PSFCH resources, and each set of PSFCH resources may contain a PSFCH with same coverage target. Each PSFCH zone may include PSFCH resources of different target coverages. The number of PSFCH resources with different coverage targets allocated in each zone can be different. That is, the number of sets of time-frequency resources for each zone may be independent of the number of sets of time-frequency resources for at least one other zone.

Due to the fact that V2X communications for proximity services are more relevant to the group of UEs geographically closed to each other, in some embodiments the number of PSFCH resources with a small coverage target can be larger than than those of large coverage target. When the V2X RX UE receives a PSSCH, the V2X RX UE can determine which PSFCH resource with appropriate coverage target available in the current zone is to be used for HARQ-ACK feedback to achieve spectrum/energy efficient PSFCH transmission. The selection of PSFCH resources can be based on the TX-RX distance estimated from the V2X TX UE location signaled in the SCI scheduling the PSSCH, as well as the SL reference signal receive power (RSRP). As a result, link adaptation of the PSFCH transmission can be achieved by the RX UE to optimize the SL spectrum efficiency and usage according to the actual radio link condition. Specifically, the PSFCH resource pool configuration in Method-1 (SL-V2X-PSFCHResourcePoolConfig) can be enhanced with the following parameters to realize the proposed functions:

```
SL-V2X-PSFCHResourcePoolConfig ::= SEQUENCE {
    slotOffsetMin ENUMERAIED {s11, s12, s14, s18, spare1},
    slotOffsetMax ENUMERATED {s11, s12, s14, s18, spare1}, OPTIONAL
  slot-Bitmap SL-V2X-SlotBitmap,
  nrofLastSymbols-PSFCH ENUMERATED {n1, n2, n4, n7, n14},
    sameSubchannel-PSSCHIndicator BOOLEAN,
  PSFCHSetList SEQUENCE (SIZE (1.. maxNrofPSFCHSets)) OF
  SL-V2X-PSFCHSetConfig
  PSFCHSetSelectionCriteria ENUMERATED
  {‘TX-RX distance’, ‘PathLoss’},
}
```

where the slotOffsetMin, slotOffsetMax, slotBitmap nrofLastSymbols-PSFCH, and sameSubchannel-PSSCHIndicator parameters may be defined as in Method-1. The PSFCHSetList may define a list of SL-V2X-PSFCHSetConfig, each of which defines a set of PSFCH resources with certain selection criteria. The maxNrofPSFCHSets parameter may define the maximum number of PSFCH resource sets can be (pre)configured for the SL V2X UE. The PSFCHSetSelectionCriteria parameter may define the criteria for the selection of a PSFCH resource from a particular PSFCH set, which can be based on either the TX-RX distance estimation or path loss estimation derived from the SL-RSRP estimation.

```
SL-V2X-PSFCHSetConfig ::= SEQUENCE {
  PSFCHSetIndex INTEGER (1..maxNrofPSFCHSets)
    sizeSubchannel ENUMERATED {n2, n4, n8, n16, n32, spare1},
  nrofSubchannels ENUMERATED {n1, n3, n5, n8, n10, n15, n20, spare1}
OPTIONAL
  startRB-PSFCH INTEGER (0..99) OPTIONAL, -- Need OR
  distanceMin ENUMERATED
  {m5, m10, m20, m50, m100, m200, m500, spare1}
OPTIONAL,
  distanceMAX ENUMERATED
  {m5, m10, m20, m50, m100, m200, m500, spare1}
OPTIONAL,
    pathLossMin ENUMERATED
    {.5 dB, 1 dB, 1.5 dB, 2 dB, 2.5 dB, 3dB, spare1}
OPTIONAL,
    pathLossMax ENUMERATED
    {.5 dB, 1 dB, 1.5 dB, 2 dB, 2.5 dB, 3 dB, spare1}
OPTIONAL,
}
```

where the PSFCHSetIndex parameter may define the index of the PSFCH resource set. The sizeSubchannel, nrofSubchannels and startRB-PSFCH parameters may be defined as in Method-1. In some aspects, different PSFCH resource sets can be allocated in a non-/partial-/fully-overlapped manner, which may depend on the settings of these three parameters. The distanceMin and distanceMax parameters may define the range of TX-RX distance in which the PSFCH resource in the set can be chosen for HARQ-ACK transmission. The pathLossMin and pathLossMax parameters may define the range of path loss between the TX UE and the RX UE in which the PSFCH resource in the set can be chosen for HARQ-ACK transmission.

The use of relative location information in addition to the RSRP allows further differential between the resources used by RX V2X UEs in different zones, as well as RX V2X UEs within the same zone.

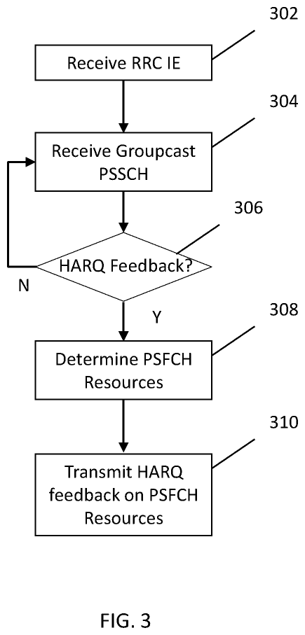

FIG. 3 illustrates a method of providing feedback in sidelink communications in accordance with some embodiments. The apparatus shown and described herein may be configured to perform one or more of the operations disclosed herein. FIG. 3 is merely exemplary; in other embodiments, other operations may be present.

At operation 302, the UE may receive an RRC IE from the gNB. The RRC IE may be received during attachment or at another time, and may be an RRC Reconfiguration IE. The RRC IE may contain sidelink communication parameters. In particular, the RRC IE may contain a PSFCH resource pool configuration with slot and subchannel parameters for transmission by the UE of HARQ feedback on a PSFCH in response to reception of data on a PSSCH.

At operation 304, after having received the RRC IE, the UE may receive a PSSCH from a TX UE. The PSSCH may be a groupcast PSSCH.

In response to reception of the PSSCH, at operation 306, the UE may determine whether or not to transmit HARQ feedback to the TX UE. For example, if option-1 HARQ processes are used and the PSSCH is successfully received by the UE, transmission of HARQ feedback may be avoided: whereas if the PSSCH is not successfully received by the UE. HARQ feedback may be transmitted to the TX UE (sending a NACK). If, however, option-2 HARQ processes are used, the UE may always transmit HARQ feedback to the TX UE (sending either an ACK or NACK).

If the UE determines, at operation 306, to send HARQ feedback, the UE may, at operation 308, select time-frequency resources of the PSFCH based on the PSFCH resource pool configuration. The selected resources may depend on a geographical zone, an identifier of the UE, and/or a coverage target of the UE.

Having determined the time-frequency resources to use at operation 308, at operation 310 the UE may transmit to the TX UE the HARQ feedback on the PSFCH. As the PSSCH is a groupcast PSSCH, the TX UE may receive multiple different HARQ feedback transmissions from a number of RX UEs on different PSFCHs for the same groupcast PSSCH.

Although an embodiment has been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

The subject matter may be referred to herein, individually and/or collectively, by the term “embodiment” merely for convenience and without intending to voluntarily limit the scope of this application to any single inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. Thus, at least one of A or B, includes one or more of A, one or more of B, or one or more of A and one or more of B. In this document, the terms “including” and “in which” are used as the plain-English equivalents of the respective terms “comprising” and “wherein.” Also, in the following claims, the terms “including” and “comprising” are open-ended, that is, a system, UE, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical parameters on their objects.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. An apparatus for a user equipment (UE) to configure the UE for New Radio (NR) vehicle-to-everything (V2X) sidelink communication, the apparatus comprising processing circuitry and a memory configured to:
decode a radio resource control (RRC) information element (IE) comprising a Physical Sidelink Feedback Channel (PSFCH) resource pool configuration, the PSFCH resource pool configuration including a time-frequency resource pool configuration for transmission by the UE of Hybrid Automatic Repeat reQuest (HARQ) feedback on a PSFCH in response to reception of a physical sidelink shared channel (PSSCH);
decode a groupcast PSSCH from a transmitting (TX) UE;
determine whether to transmit HARQ feedback on a PSFCH in response to the groupcast PSSCH;
in response to a determination to transmit HARQ feedback, select time-frequency resources of the PSFCH based on the PSFCH resource pool configuration; and
generate, for transmission to the TX UE, the HARQ feedback on the time-frequency resources of the PSFCH.

2. The apparatus of claim 1, wherein the RRC IE comprises a minimum and maximum slot offset with respect to a slot on which the groupcast PSSCH was received, a bitmap pattern for a set of slots in which the PSFCH is allocated, and a number of last Orthogonal Frequency Division Multiplexing (OFDM) symbols in a particular slot of the set of slots to be used for transmission of the PSFCH.

3. The apparatus of claim 2, wherein a periodicity of PSFCH slot pattern is dependent on a length of bitmap.

4. The apparatus of claim 2, wherein the RRC IE further comprises a number of resource blocks per PSFCH subchannel, a number of subchannels in a PSFCH resource pool, and, if present, a number of start resource blocks in a carrier bandwidth.

5. The apparatus of claim 4, wherein the processing circuitry is further configured to determine that a start resource block of the PSFCH is same as that of the PSSCH if a field indicating the number of start resource blocks is absent from the RRC IE.

6. The apparatus of claim 1, wherein the RRC IE comprises an indicator bit that indicates whether a same subchannel is to be used for the PSSCH and PSFCH.

7. The apparatus of claim 6, wherein if the indicator bit indicates that different subchannels are to be used for the PSSCH and PSFCH, the processing circuitry is further configured to determine frequency resources to be used by the PSFCH from Sidelink Control Information (SCI) associated with the PSSCH.

8. The apparatus of claim 1, wherein:
the PSFCH resource pool configuration further comprises zone information that maps time-frequency resources to geographical zones, and
the processing circuitry is further configured to:
determine a local zone in which the apparatus is located; and
select the time-frequency resources of the PSFCH based further on the local zone.

9. The apparatus of claim 8, wherein the PSFCH resource pool configuration provides a single time-frequency resource if an Option-1 HARQ response is configured as the HARQ feedback.

10. The apparatus of claim 8, wherein the PSFCH resource pool configuration provides a pair of time-frequency resources if an Option-2 HARQ response is configured as the HARQ feedback.

11. The apparatus of claim 8, wherein:
the PSFCH resource pool configuration provides multiple sets of time-frequency resources for each geographical zone, and
the processing circuitry is further configured to select the time-frequency resources of the PSFCH from among the sets of time-frequency resources associated with the local zone based further on a location identity or layer 1 identity of the apparatus.

12. The apparatus of claim 8, wherein:
the PSFCH resource pool configuration provides multiple sets of time-frequency resources for each geographical zone, each set of time-frequency resources for a particular geographical zone associated with a different coverage target, and
the processing circuitry is further configured to select the time-frequency resources of the PSFCH from among the sets of time-frequency resources associated with the local zone based further on a coverage target of the apparatus.

13. The apparatus of claim 12, wherein a number of sets of time-frequency resources for each geographical zone is independent of the number of sets of time-frequency resources for at least one other geographical zone.

14. The apparatus of claim 12, wherein the processing circuitry is further configured to:
estimate a distance from the TX UE based on a TX UE location in Sidelink Control Information (SCI) associated with the PSSCH; and
select the time-frequency resources of the PSFCH from among the sets of time-frequency resources associated with the local zone based further on the distance from the TX UE estimated and a reference signal receive power (RSRP) of the PSSCH.

15. The apparatus of claim 14, wherein:
the RRC IE comprises a PSFCH resource pool configuration for each set of time-frequency resources, and
each PSFCH resource pool configuration comprises a minimum and maximum distance from the TX UE and a minimum and maximum RSRP for selection of the set of time-frequency resources associated with the PSFCH resource pool configuration.

16. An apparatus for a New Radio (NR) NodeB (gNB), the apparatus comprising processing circuitry and a memory configured to:
encode, for transmission to a user equipment (UE), a radio resource control (RRC) information element (IE) that contains a Physical Sidelink Feedback Channel (PSFCH) resource pool configuration for vehicle-to-everything (V2X) sidelink communication, the PSFCH resource pool configuration including time-frequency resources for transmission by the UE of Hybrid Automatic Repeat reQuest (HARQ) feedback on a PSFCH in response to reception of groupcast data on a physical sidelink shared channel (PSSCH) from another UE,
wherein the RRC IE comprises slot and subchannel parameters for the UE to use for the HARQ feedback.

17. The apparatus of claim 16, wherein the slot and subchannel parameters comprise:
a minimum and maximum slot offset with respect to a slot on which the groupcast PSSCH was received,
a bitmap pattern for a set of slots in which the PSFCH is allocated,
a number of last Orthogonal Frequency Division Multiplexing (OFDM) symbols in a particular slot of the set of slots to be used for transmission of the PSFCH,
a number of resource blocks per PSFCH subchannel,
a number of subchannels in a PSFCH resource pool, and,
if present, a number of start resource blocks in a carrier bandwidth.

18. The apparatus of claim 17, wherein the slot and subchannel parameters further comprise an indicator bit that indicates whether a same subchannel is to be used for the PSSCH and PSFCH.

19. A computer-readable storage medium that stores instructions for execution by one or more processors of a user equipment (UE) to configure the UE for New Radio (NR) vehicle-to-everything (V2X) sidelink communication, the instructions, when executed, configure the one or more processors to:
determine, from a radio resource control (RRC) information element (IE) that contains a Physical Sidelink Feedback Channel (PSFCH) resource pool configuration, slot and subchannel parameters for transmission by the UE of Hybrid Automatic Repeat reQuest (HARQ) feedback on a PSFCH in response to reception of data on a physical sidelink shared channel (PSSCH);
determine, in response to reception of a groupcast PSSCH from a transmitting (TX) UE, whether to transmit HARQ feedback on a PSFCH in response to the groupcast PSSCH;
in response to a determination to transmit HARQ feedback, select time-frequency resources of the PSFCH based on the PSFCH resource pool configuration; and
generate, for transmission to the TX UE, the HARQ feedback on the time-frequency resources of the PSFCH.

20. The medium of claim 19, wherein the slot and subchannel parameters comprise:
a minimum and maximum slot offset with respect to a slot on which the groupcast PSSCH was received,
a bitmap pattern for a set of slots in which the PSFCH is allocated,
a number of last Orthogonal Frequency Division Multiplexing (OFDM) symbols in a particular slot of the set of slots to be used for transmission of the PSFCH,
a number of resource blocks per PSFCH subchannel,
a number of subchannels in a PSFCH resource pool, and,
if present, a number of start resource blocks in a carrier bandwidth.
